(19) United States
(12) Patent Application Publication
(10) Pub. No.: US 2007/0204429 A1
(43) Pub. Date: Sep. 6, 2007

(54) Direction lock assembly of caster for rolling walker

(76) Inventor: Juei-Chuan Cheng, Taichung (TW)

Correspondence Address: JUEI-CHUAN CHENG, P.O. BOX 219, TAICHUNG, TW

(21) Appl. No.: 11/367,364

(22) Filed: Mar. 6, 2006

(51) Int. Cl. B60B 33/00

(52) U.S. Cl. 16/35 R

(57) ABSTRACT

A direction lock assembly of a caster for a rolling walker comprises a pin housing, a lock pin and a caster base. The pin house sets a pin chamber for inserting a lock pin and attaches on an end of walker's front leg and pivotally connects with a caster base. The pin house has a passage outside of the pin chamber with two notches located on both ends. A handle connects with the lock pin through the passage of the lock housing. Therefore, the handle of the lock pin can switch the pin between the first position, pulling the handle up to an upper notch to hold the pin in an upper location for opening the lock to free the rotation of the caster in any direction, and the second position, pulling the handle down to a lower notch to hold the pin in a lower location for fixing the caster in the forward and backward direction. The caster base comprises a pivot shaft joined with the pivot bore for the caster to rotate in any direction, a pair of wheel support with a wheel pivot hole on each to joint with an axle of a caster wheel, and a pin bore for the lock pin to insert into thereof for fixing the caster in the forward and backward direction.

### FIELD OF THE INVENTION

The present invention relates to a caster. More particularly, the present invention relates to the caster of a rolling walker that can take various forms to be used, for example, an apparatus for enabling aged or disabled people to walk or to help them walk or as a walking trainer. It is noted that a term “rolling walker” is used in this specification as a general term for apparatuses having at least a frame, a caster and a handle particularly for helping aged people or disabled people to walk in order to walk easily, and is a concept including all kinds of lightweight cars called a walker, a walking trainer, a rolling walker for aged people or the like.

### BACKGROUND OF THE INVENTION

The conventional art, which has been patented to Hara in U.S. Pat. No. 6,494,469, the rolling walker, has a straight moving means which fixes the front caster in the forward and backward direction of the rolling walker and the front caster is a rotatable caster having the caster rotational axis around which the front caster rotates so that all casters and can be fixed in the forward and backward direction, ensuring straightness in walking. The straight moving means includes a lock member movably attached to the first frame and a locking recess formed in both the first frame and the front caster to be over engaged with the lock member to restrict rotation of the front caster.

The above art has the drawbacks as following. The lock member of the above art lacks a securing means for securing the lock member in either open position or lock position. Therefore, the lock member may slip away from the lock position when the front casters bump on an obstructer. As using in a lasting time, the lock member may loose to drop down and lock the caster automatically by the gravity.

### SUMMARY OF THE INVENTION

An embodiment of the present invention overcome the above-described shortcomings of prior art and satisfy a significant need of a rolling walker, which can lock and secure the caster in the forward and backward direction or open and secure to free the caster to rotate in any direction. It is also convenient to maintain and to repair the assembly of the lock member.

For achieving above aims, the embodiment of the present invention, a direction lock assembly of a rolling walker, comprises a lock housing, a lock pin, and a caster base. The lock housing sets a pin chamber for inserting a lock pin and attaches on an end of walker's front leg and pivotally connects with the caster base. The pin house also has a passage outside of the pin chamber with two secure notches located on both ends. A handle connects with the lock pin through the passage of the lock housing. Therefore, the handle of the lock pin can switch the pin between the first position, pulling the handle up to an upper notch to hold the pin in an upper location for opening the lock to free the rotation of the caster in any direction, and the second position, pulling the handle down to a lower notch to hold the pin in a lower location for fixing the caster in the forward and backward direction. A spring sets inside of handle to force the handle held in the notches. The caster base comprises a pivot shaft joined with the pivot bore for the caster to rotate in any direction, a pair of wheel support with a wheel pivot hole on each to joint with an axle of a caster wheel, and a pin bore for the lock pin to insert into thereof for fixing the caster in the forward and backward direction.

Objects and advantages of the present invention will become apparent from reading the following description of the invention wherein reference is made to the accompanying drawings.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is an explored view of the preferred embodiment;

FIG. 2 is a perspective view of the preferred embodiment;

FIG. 3 is a crossing view of the preferred embodiment as the pin in lock position;

FIG. 4 is a crossing view of the preferred embodiment as a lock pin in first position;

FIG. 5 is a perspective view of the preferred embodiment assembled on a foldable rolling walker.

### DETAILED DESCRIPTION OF THE PREFERRED EMBODIMENT

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough and complete, and will fully convey the scope of the invention to those skilled in the art.

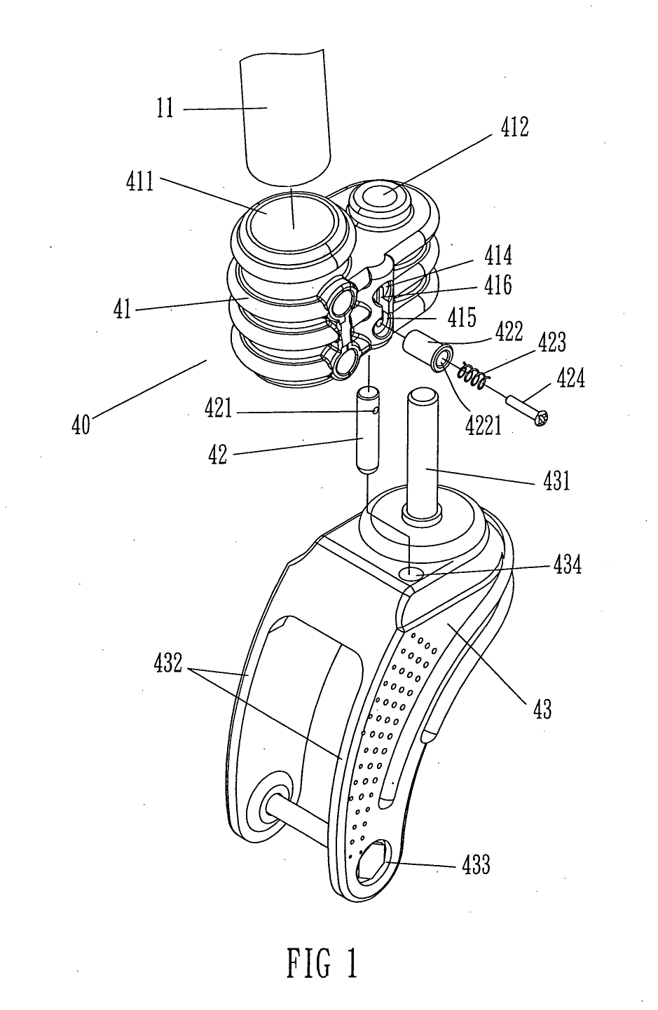

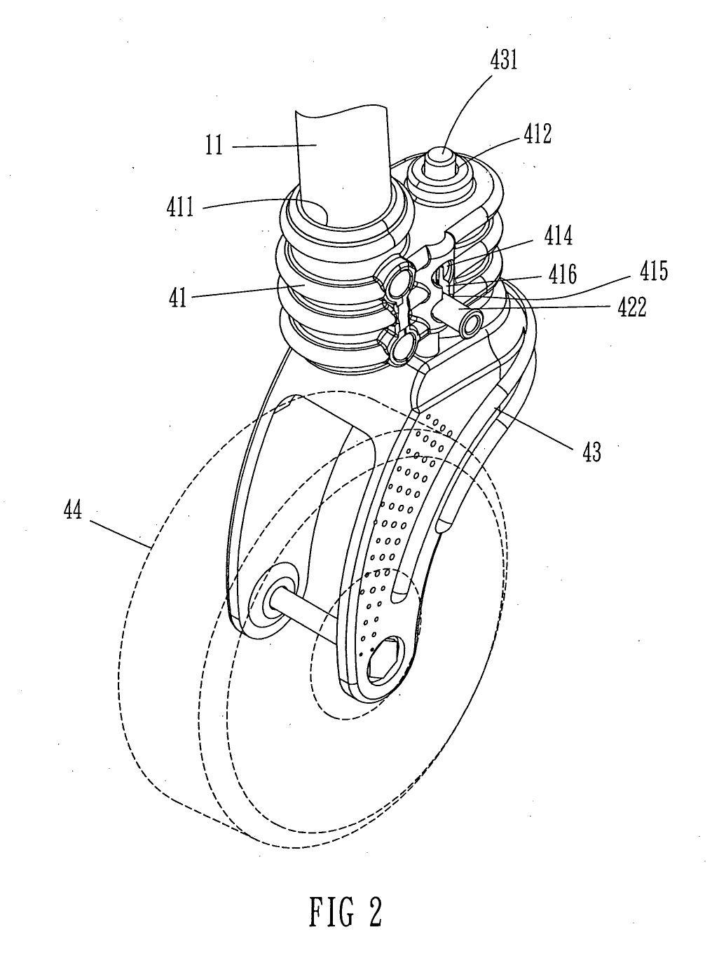

As shown in FIGS. 1 to 5, the preferred embodiment, a direction lock assembly of a caster 40, comprises a lock housing 41, a lock pin 42, and a caster base 43. The lock housing 41 includes a connecting chamber 411 for attachment to a leg 11 of the rolling walker 10, a pivot bore 412 for the connection with a pivot shaft 431 of the caster base, and a pin chamber 413 set for the lock pin 42 to shift. A passage 416 longitudinally set outside of the pin chamber 413 has two notches 414, 415 on both ends for the limit of the handle 422 to secure thereon. The lock pin 42 attaches with a handle 422 by a screw 424 on a screw hole 421 thereof and locates inside of the pin chamber 413 for shifts, up and down. The handle 422 has a spring chamber 4221 for a spring 423 and the screw 424 to set in. The spring 423 sets in the spring chamber 4221 of the handle 422, which one end is against the rim of a screw passage 4222 of the handle 422 and the other end against the head of the screw 424. The screw 424 inserts through the spring 423 and then the screw passage 4222 and fasten on the screw hole 421 of the lock pin 42.

The caster base 43 comprises a pivot shaft 431 pivotally attached on the pivot bore 412 of the pin housing 41, a pair of wheel support 432 set an axle hole 433 on each for connecting with an axle of the wheel 44, and at least a pin bore 434 correspondingly with the lock pin 42 to insert therein.

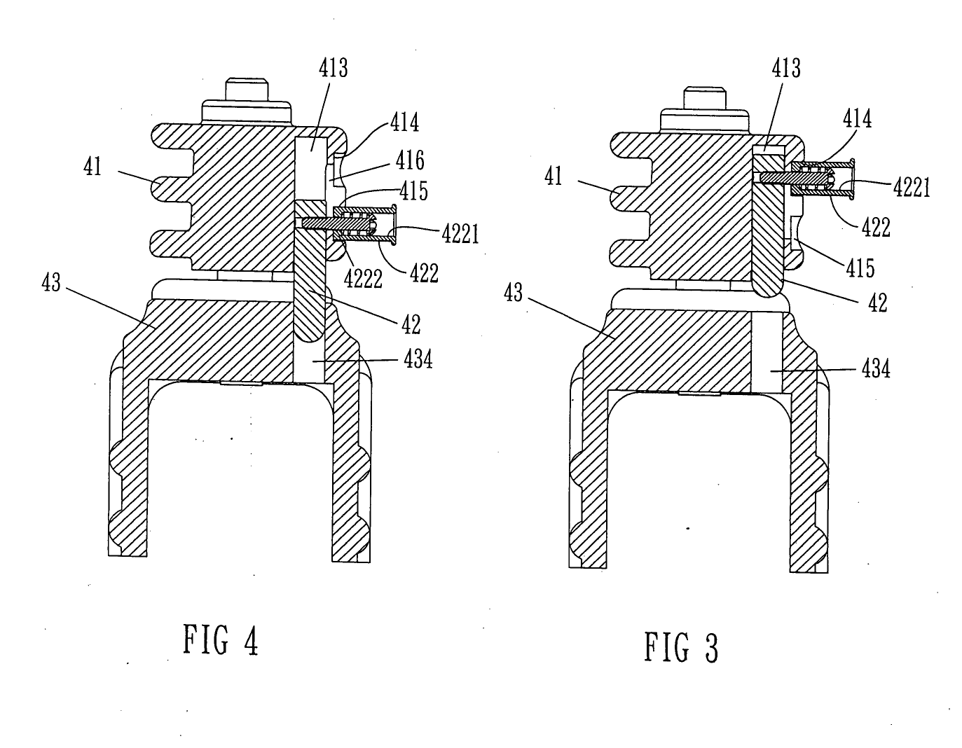

As shown in FIGS. 3 and 4, the handle 422 can switch the lock pin 42 between the first position, pulling the handle out and up to secure in an upper notch 414 to hold the pin 42 in an upper location for opening the lock to free the rotation of the caster 40 in any direction, and the second position, pulling out and down to secure in a lower notch 415 to hold the pin 42 in a lower location for fixing the caster 40 in the forward and backward direction. When the handle 422 sets into the notches 414, 415, the spring 423 pushes the handle 422 for securing the handle 422 in the notches 414, 415.

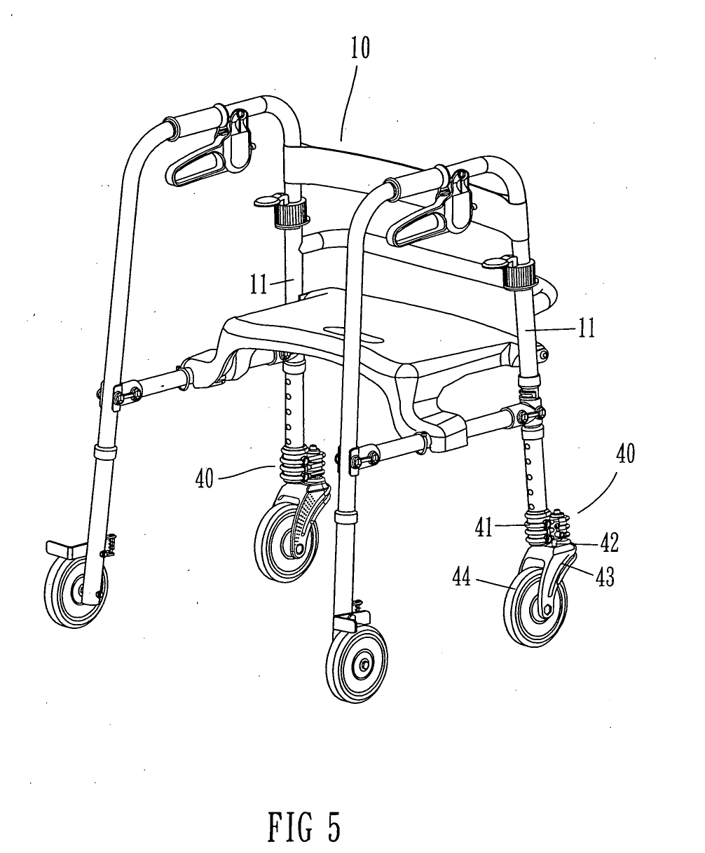

As shown in FIG. 5, the rotatable casters 40 are attached on the front leg 11 of the rolling walker 10 for guiding the walker 10 to turn in any direction when the lock pin 42 in the first position or in the forward and backward direction when the lock pin 42 in the second position.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A direction lock assembly of a rotatable caster comprises
a pin housing including an attachment to attach on a support end of a walker,
a pivot bore pivotally joined to a pivot shaft of the caster, and at least a pin chamber set a longitudinal passage with an upper notch and a lower notch;
a lock pin setting inside of the pin chamber with an attachment on upper end to attach a handle for switching and holding in either upper or lower notches;
a caster base including the pivot shaft to join with the pivot bore of the pin housing, at least a wheel support with a pivot hole to connect with a wheel, and at least a pin bore on the top correspondingly to match and limit the lock pin therein.

2. The direction lock assembly according to claim 1, wherein said handle set a chamber for a screw and the elastic means to insert therein and a screw passage for the screw to pass through and to connect with the lock pin through the passage of the pin housing.

3. The direction lock assembly according to claim 2, wherein said elastic means can force the handle holding in the upper notch for the lock pin in the upper position to free the rotation of caster in any direction, and in the lower notch for the lock pin in the lower position to fix the caster in the forward and backward direction.
